(19) United States
(12) Patent Application Publication
(10) Pub. No.: US 2026/0105583 A1
(43) Pub. Date: Apr. 16, 2026

(54) INSPECTION SYSTEM FOR IMAGE DISPLAY DEVICES

(71) Applicant: Samsung Display Co., LTD., Yongin-si (KR)

(72) Inventors: Young Sang HA, Yongin-si (KR); Ha Young LEE, Yongin-si (KR); Jin SEO, Yongin-si (KR); Youn Ho HAN, Yongin-si (KR)

(21) Appl. No.: 19/193,121

(22) Filed: Apr. 29, 2025

(30) Foreign Application Priority Data
Oct. 11, 2024 (KR) 10-2024-0138185

(51) Int. Cl. G06T 7/00; G06T 7/11; G06T 7/90; G06V 10/764; G06V 10/98

(52) U.S. Cl. CPC G06T 7/0002; G06T 7/11; G06T 7/90; G06V 10/764; G06V 10/98; G06T 2200/24; G06T 2207/20081; G06T 2207/30121; G06T 2207/30168

(57) ABSTRACT

An inspection system for image display devices includes: an image detector generating inspection image data in units of at least one frame by photographing image display devices folded at a preset folding angle; and a quality analyzer classifying a class of each of the folded image display devices and determining whether each of the folded image display devices is non-defective by comparing the inspection image data with reference class classification image data, which are classified by the class, through a preset learning program.

This application claims priority to Korean Patent Application No. 10-2024-0138185, filed on Oct. 11, 2024, and all the benefits accruing therefrom under 35 U.S.C. § 119, the content of which in its entirety is herein incorporated by reference.

### BACKGROUND

### 1. Field

The disclosure relates to an inspection system for image display devices.

### 2. Description of the Related Art

As the information society develops, demands for display devices for displaying images are increasing in various forms. For example, display devices are applied to various electronic devices such as smartphones, digital cameras, laptop computers, navigation devices, and smart televisions.

The display devices may be flat panel display devices such as liquid crystal display devices, field emission display devices, and organic light-emitting display devices. Among these flat panel display devices, an organic light-emitting display device includes a light-emitting element that enables each pixel of a display panel to emit light by itself. Thus, the organic light-emitting display device may display an image without a backlight unit that provides light to the display panel.

Recently, various types of display devices that may selectively adjust an image display area, unlike simply formed flat panel display devices, are being developed. For example, various types of flexible display devices, such as foldable display devices, rollable display devices, bendable display devices, curved display devices, and stretchable display devices, are being developed.

### SUMMARY

Features of the disclosure provide an inspection system for image display devices which may detect image quality degradation characteristics of a folding area and a folding peripheral area of display devices, such as foldable display devices capable of changing their image display area and angle, by a machine learning (e.g., deep learning) algorithm and program.

Features of the disclosure also provide an inspection system for image display devices which may accurately check the image display quality of flexible display devices such as foldable, rollable and curved display devices and check whether the flexible display devices are non-defective by deriving the degree of degradation of image quality, such as luminance and chrominance, numerically or by grade (or level).

However, features of the disclosure are not restricted to the one set forth herein. The above and other features of the disclosure will become more apparent to one of ordinary skill in the art to which the disclosure pertains by referencing the detailed description of the disclosure given below.

In an embodiment of the disclosure, an inspection system for image display devices includes an image detector generating inspection image data in units of at least one frame by photographing image display devices folded at a preset folding angle and a quality analyzer classifying a class of each of the folded image display devices and determining whether each of the folded image display devices is non-defective by comparing the inspection image data with reference class classification image data, which are classified by the class, through a preset learning program.

In an embodiment of the disclosure, an inspection system for image display devices includes an image detector generating inspection image data in units of at least one frame by photographing image display devices folded at a preset folding angle, and a quality analyzer classifying a class of each of the folded image display devices and determining whether each of the folded image display devices is non-defective by comparing the inspection image data with reference class classification image data, which are classified by the class, through a preset learning program, where the image detector generates first inspection image data for each folding angle by photographing the image display devices, which are sequentially changed to each preset folding angle, using the image capturing device, generates second inspection image data for each folding angle by sequentially photographing the image display devices which are changed to each preset folding angle while displaying a preset inspection image, and transmits the first inspection image data for each folding angle and the second inspection image data for each folding angle to the quality analyzer.

An inspection system for image display devices in embodiments may detect image quality degradation characteristics of a folding area and a folding peripheral area of flexible display devices, such as foldable display devices, by a machine learning algorithm and application program, thereby clearly identifying the cause of quality degradation and improvement measures.

In addition, the inspection system may more accurately inspect the image display quality of flexible display devices such as foldable, rollable and curved display devices and evaluate whether the flexible display devices are non-defective by deriving the degree of degradation of image quality, such as luminance and chrominance, numerically or by grade (or level).

However, the effects of the disclosure are not restricted to the one set forth herein. The above and other effects of the disclosure will become more apparent to one of daily skill in the art to which the disclosure pertains by referencing the claims.

### BRIEF DESCRIPTION OF THE DRAWINGS

These and/or other features will become apparent and more readily appreciated from the following description of the embodiments, taken in conjunction with the accompanying drawings in which:

FIG. 1 illustrates an embodiment of an inspection system for image display devices according to the disclosure;

FIG. 2 is a perspective view of an embodiment of a foldable type image display device;

FIG. 3 is a configuration diagram illustrating a folding area, folding peripheral areas, and flat display areas defined in a display area of FIG. 2;

FIG. 4 is a cross-sectional view illustrating the change in the curvature of an image display surface according to the change in the folding angle of the image display device illustrated in FIGS. 2 and 3;

FIG. 5 is a block diagram illustrating detailed components of a quality analyzer illustrated in FIG. 1;

FIG. 6 illustrates, at each folding angle, a display area segmented screen of a display device photographed and detected by an image detector of FIG. 1;

FIG. 7 illustrates, at each folding angle, an image display area of a display device photographed and detected by the image detector of FIG. 1;

FIG. 8 illustrates a method of extracting sampling areas from a folding peripheral area and a flat area of the display area;

FIG. 9 is a graph illustrating a method of analyzing a difference in luminance between sampling areas in a folding peripheral area and a flat area of FIG. 8;

FIG. 10 is a graph illustrating a method of analyzing the chrominance of sampling areas in a peripheral area and a flat area of FIG. 8;

FIG. 11 is an example classification diagram illustrating first reference image data stored in a first database of FIG. 5 by folding angle and determination standard;

FIG. 12 is an example classification diagram illustrating second reference image data stored in a second database of FIG. 5 by folding angle and determination standard;

FIG. 13 is an example classification diagram illustrating third reference image data stored in a third database of FIG. 5 by folding angle and determination standard; and

FIG. 14 illustrates an application program screen displayed through a monitor.

### DETAILED DESCRIPTION

The disclosure will now be described more fully hereinafter with reference to the accompanying drawings, in which preferred embodiments of the disclosure are shown. This disclosure may, however, be embodied in different forms and should not be construed as limited to the embodiments set forth herein. Rather, these embodiments are provided so that this disclosure will be thorough and complete, and will filly convey the scope of the disclosure to those skilled in the art.

It will also be understood that when a layer is referred to as being “on” another layer or substrate, it may be directly on the other layer or substrate, or intervening layers may also be present. The same reference numbers indicate the same components throughout the specification.

It will be understood that, although the terms “first,” “second,” etc., may be used herein to describe various elements, these elements should not be limited by these terms. These terms are only used to distinguish one element from another element. For instance, a first element discussed below could be termed a second element without departing from the teachings of the disclosure. Similarly, the second element could also be termed the first element.

The terms such as “detector”, “analyzer”, “device” and “unit” as used herein are intended to mean a hardware component such as a circuitry that performs a predetermined function. The hardware component may include a field-programmable gate array (“FPGA”) or an application-specific integrated circuit (“ASIC”), for example.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term “about” can mean within one or more standard deviations, or within ±30%, 20%, 10%, 5% of the stated value, for example.

Each of the features of the various embodiments of the disclosure may be combined or combined with each other, in part or in whole, and technically various interlocking and driving are possible. Each embodiment may be implemented independently of each other or may be implemented together in an association.

Hereinafter, illustrative embodiments will be described with reference to the accompanying drawings.

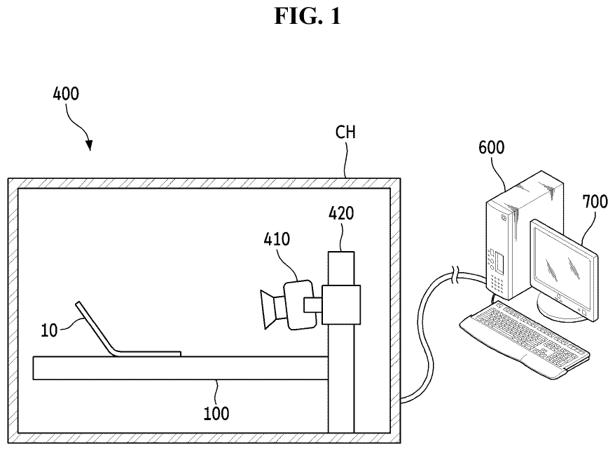

FIG. 1 illustrates an embodiment of an inspection system for image display devices according to the disclosure.

Referring to FIG. 1, the inspection system for image display devices in the embodiment includes an image detector 400 which photographs flexible type image display devices 10 (hereinafter, also referred to as display devices) such as foldable image display devices and a quality analyzer 600 which inspects whether the display devices 10 are non-defective by analyzing the display devices 10 and captured image data (or inspection image data) of image display screens of the display devices 10. The quality analyzer 600 may display the quality inspection results as an application program screen on a separate display unit 700 such as a monitor.

The image detector 400 captures each of the display devices 10 and images displayed on each of the display devices 10 and generates and detects captured image data in units of at least one frame.

The image detector 400 includes one or more loading plates 100, an image capturing device 410, and a body frame 420. In addition, the image detector 400 may further include a chamber CH in which the loading plates 100, the image capturing device 410 and the body frame 420 are disposed or accommodated therein and which defines a darkroom space.

The loading plates 100 of the image detector 400 sequentially move and place the display devices 10 aligned and disposed on the loading plates 100 to a preset photographing position. In an embodiment, the loading plates 100 may be disposed on a rail and may sequentially move and place the display devices 10 to the preset photographing position while sequentially moving along the rail, for example.

The body frame 420 is configured such that at least one support member which supports and fixes the image capturing device 410 may be moved and coupled in a height direction (or a vertical direction) to adjust the photographing position and height of the image capturing device 410.

The image capturing device 410 includes at least one image sensor or at least one image capturing camera.

The display devices 10 are placed at a preset folding angle or at a modified folding angle on the loading plates 100. Accordingly, the image capturing device 410 photographs each of the display devices 10 maintained at the preset folding angle or changed to the modified folding angle on the loading plates 100 and generates and detects first inspection image data in units of at least one frame. Then, the image capturing device 410 first transmits the first inspection image data, which are generated sequentially, to the quality analyzer 600.

The folding angle of each of the display devices 10 placed on the loading plates 100 may be sequentially changed to different preset folding angles by an administrator or a robot device during an inspection period. In an embodiment, during the inspection period, the folding angle of each of the display devices 10 may be sequentially changed to folding angles of 60 degrees, 70 degrees, 80 degrees, 90 degrees, etc. for each preset period, for example. Accordingly, the image capturing device 410 may generate first inspection image data for each folding angle by photographing each of the display devices 10 which are sequentially changed to each folding angle. Then, the image capturing device 410 may sequentially transmit the first inspection image data for each folding angle to the quality analyzer 600.

In addition, the display devices 10 may display a preset inspection image at a preset inspection time in each period in which they are maintained at a preset folding angle or changed to another preset folding angle on the loading plates 100. Accordingly, the image capturing device 410 sequentially photographs the display devices 10 which are maintained at the preset folding angle or changed to each preset folding angle while displaying the preset inspection image. Then, the image capturing device 410 generates and detects second inspection image data for each folding angle in units of at least one frame based on the photographing result.

The image capturing device 410 transmits the sequentially generated first inspection image data for each folding angle to the quality analyzer 600 and then transmits the sequentially generated second inspection image data for each folding angle to the quality analyzer 600.

The quality analyzer 600 prepares first reference class classification image data for determining the degree of luminance and chrominance distortion and quality of captured images of the display devices 10 changed to each preset folding angle, that is, the first inspection image data for each folding angle and stores the first reference class classification image data in a database. Here, the first reference class classification image data may be extracted from previous experimental results and previous luminance and chrominance distortion degree inspection results through a preset learning program and may be stored in a memory as a database.

In addition, the quality analyzer 600 segments an image display area from the first inspection image data for each folding angle and generates segmented screen image data for each folding angle. Then, it prepares reference class screen classification image data for determining the degree of luminance and chrominance distortion and quality of the segmented screen image data for each folding angle and stores the reference class screen classification image data in a database. The reference class screen classification image data may be extracted from previous experimental results and previous luminance and chrominance distortion degree inspection results through a preset learning program and may be stored in a memory as a database.

The quality analyzer 600 prepares second reference class classification image data for determining the degree of luminance and chrominance distortion and quality of captured images of the display devices 10 displaying a preset inspection image for each preset folding angle, that is, the second inspection image data for each folding angle and stores the second reference class classification image data in a database. Here, the second reference class classification image data may be extracted from previous experimental results and previous luminance and chrominance distortion degree inspection results through a preset learning program and may be stored in a memory as a database.

The quality analyzer 600 sequentially stores, in a temporary memory, the first inspection image data for each folding angle which are sequentially input from the image capturing device 410. Then, it sequentially compares and analyzes the first inspection image data with the first reference class classification image data through a preset learning program according to an administrator's control through an application program.

The quality analyzer 600 determines a class according to the degree of luminance and chrominance distortion of the first inspection image data based on the result of comparing the first reference class classification image data and the first inspection image data.

In an embodiment, the quality analyzer 600 may detect data including grayscale values and chrominance values of folding peripheral areas around a folding area and data including grayscale values and chrominance values of flat display areas from the first inspection image data, for example. Hereinafter, the data including the grayscale values and the chrominance values may be also referred to as “image-grayscale-chrominance data”. Then, it may classify and determine the class of each piece of the first inspection image data according to a difference data value between the image-grayscale-chrominance data (e.g., grayscale values and chrominance values) of the folding peripheral areas and the image-grayscale-chrominance data (e.g., grayscale values and chrominance values) of the flat display areas.

The quality analyzer 600 also detects a difference data value between image-grayscale-chrominance data (e.g., grayscale values and chrominance values) of the folding peripheral areas and image-grayscale-chrominance data (e.g., grayscale values and chrominance values) of the flat display areas from the first reference class classification image data and classifies and determines the class of each piece of the first reference class classification image data according to the difference data value. In an embodiment, each piece of the first reference class classification image data may be classified as the class of any one of first through fifth levels, for example.

Accordingly, the quality analyzer 600 compares data including a difference value of gray scale values and chrominance values between the folding peripheral areas and the flat display areas of the first inspection image data with data including a difference value of gray scale values between the folding peripheral areas and the flat display areas of the first reference class classification image data. Hereinafter, the data including the difference value of gray scale values and chrominance values may be also referred to as “image-grayscale-chrominance-difference data”. Then, it may classify and set the class of each piece of the first inspection image data to the class (e.g., the class of any one of the first through fifth levels) of any one piece of the first reference class classification image data, whose image-grayscale-chrominance-difference data is most similar to image-grayscale-chrominance-difference data of the piece of the first inspection image data, based on the comparison result.

The quality analyzer 600 may display the class classification and setting results of the first inspection image data on a result screen of an application program and may determine and derive whether a corresponding display device 10 is non-defective based on the classified and set class of each piece of the first inspection image data.

In addition, the quality analyzer 600 may detect image-grayscale-chrominance-difference data between the folding peripheral areas and the flat display areas of the segmented screen image data for each folding angle and compare the image-grayscale-chrominance-difference data with image-grayscale-chrominance-difference data between the folding peripheral areas and the flat display areas of the reference class screen classification image data. Then, it may classify and set the class of each piece of the segmented screen image data for each folding angle to the class (e.g., the class of any one of the first through fifth levels) of any one piece of the reference class screen classification image data, whose image-grayscale-chrominance-difference data is most similar to image-grayscale-chrominance-difference data of the piece of the segmented screen image data, based on the comparison result.

In an alternative embodiment, the quality analyzer 600 may detect image-grayscale-chrominance-difference data between the folding peripheral areas and the flat display areas of the second inspection image data and compare the image-grayscale-chrominance-difference data with image-grayscale-chrominance-difference data between the folding peripheral areas and the flat display areas of the second reference class classification image data. Then, it may classify and set the class of each piece of the second inspection image data to the class (e.g., the class of any one of the first through fifth levels) of any one piece of the second reference class classification image data, whose image-grayscale-chrominance-difference data is most similar to image-grayscale-chrominance-difference data of the piece of the second inspection image data, based on the comparison result.

The quality analyzer 600 may display the class classification and setting results of the second inspection image data on a result screen of an application program and may determine and derive whether a corresponding display device 10 is non-defective according to the classified and set class of each piece of the second inspection image data.

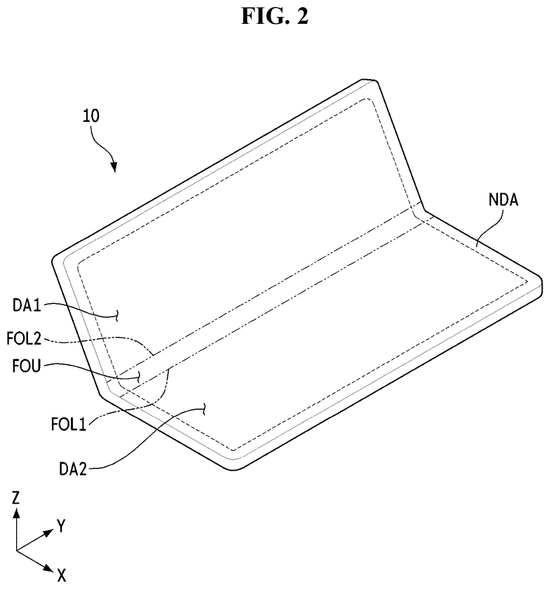

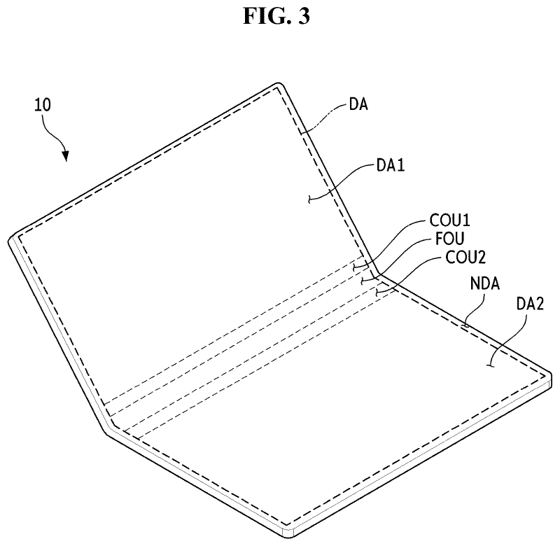

FIG. 2 is a perspective view of a foldable type image display device 10. FIG. 3 is a configuration diagram illustrating a folding area FOU, folding peripheral areas COU1 and COU2, and flat display areas DA1 and DA2 defined in a display area DA of FIG. 2.

Referring to FIGS. 2 and 3, the foldable type image display device (hereinafter, also referred to as a display device 10) in the embodiment is of a foldable type and may be applied to portable electronic devices such as mobile phones, smartphones, tablet personal computers (“PCs”), mobile communication terminals, electronic notebooks, electronic books, portable multimedia players (“PMPs”), navigation devices, and ultra-mobile PCs (“UMPCs”). In an alternative embodiment, the display device 10 in the embodiment may be applied as a display unit of a television, a laptop computer, a monitor, a billboard, or an Internet of things (“IoT”) device.

In FIGS. 2 and 3, the display device 10 is a foldable display device that may be folded once in a first direction (X-axis direction). However, the display device 10 may also be changed to or maintained in a folded state in which it is folded once, a flex state in which it is bent only at a predetermined angle, and a flat state in which it is completely unfolded and flat.

The display device 10 may be folded in an in-folding manner in which a front surface, i.e., an image display surface is placed inside. When the display device 10 is bent or folded in the in-folding manner, portions of the front surface of the display device 10 may face each other.

In an embodiment, the display area (also referred to as a front image display area) DA of the in-folding display device 10 may be divided into first and second flat display areas DA1 and DA2, first and second folding peripheral areas COU1 and COU2, and one folding area FOU, for example. Therefore, when the display device 10 is unfolded, an image may be displayed on the front surface in the first and second flat display areas DA1 and DA2, the first and second folding peripheral areas COU1 and COU2, and the folding area FOU of the display device 10.

One folding area FOU may be disposed between the first and second flat display areas DA1 and DA2, and areas between sides of the folding area FOU and the first and second flat display areas DA1 and DA2 may be the first and second folding peripheral areas COU1 and COU2 of the folding area FOU.

A non-display area (also referred to as an image non-display area) NDA may be formed outside the display area DA, that is, outside at least one folding area FOU, the first and second folding peripheral areas COU1 and COU2 of the folding area FOU, and the first and second flat display areas DA1 and DA2.

The first flat display area DA1 may be disposed on a side of the folding area FOU and the first folding peripheral area COU1, e.g., on a right side of the first folding peripheral area COU1. In addition, the second flat display area DA2 may be disposed on an opposite side of the folding area FOU and the second folding peripheral area COU2, e.g., on a left side of the second folding peripheral area COU2.

The folding area FOU and first and second folding lines FOL1 and FOL2, which are boundaries of the folding area FOU, may extend in a second direction (Y-axis direction), and the display device 10 may be folded in the first direction (X-axis direction).

When the folding area FOU is folded in an in-folding manner, front surfaces of the first and second flat display areas DA1 and DA2 may face each other. When the folding area FOU extending in the second direction (Y-axis direction) is in-folded or out-folded in the first direction (X-axis direction), a width of the display device 10 in the first direction (X-axis direction) may be reduced by about half.

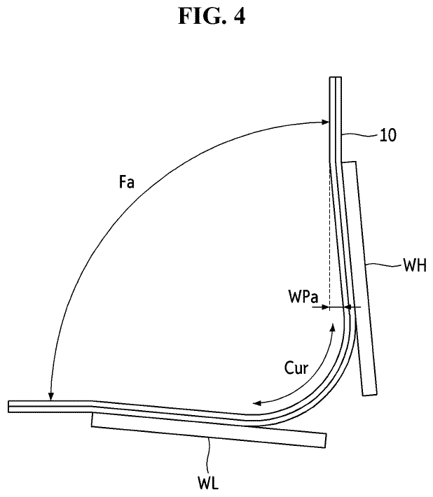

FIG. 4 is a cross-sectional view illustrating the change in the curvature of the image display surface according to the change in the folding angle of the display device 10 illustrated in FIGS. 2 and 3. In addition, Table 1 below numerically shows the change in the lateral angle of the first and second folding peripheral areas COU1 and COU2 and the change in the curvature of the folding portion area according to the change in the folding angle of the display device 10.

TABLE 1

| | |
|---|---|
| DOE | Dumbbell-type |

| | | | | |
|---|---|---|---|---|
| Folding angle (°) | 60 | 70 | 80 | 90 |
| Curvature (R@mm) | 11.85 | 10.04 | 6.69 | 7.65 |
| Wing plate tilt angle (°) | 7.12 | 7.75 | 8.36 | 9 |

Referring to Table 1 together with FIG. 4, as a folding angle Fa of the display device 10 is wider, curvature Cur of the folding area FOU increases, and the internal curvature between wing plates WH and WL applied as supports inside the display device 10 also increases. As the internal curvature of the folding area FOU and the internal curvature between the wing plates WH and WL increase, a change in the angle of the first folding peripheral area COU1, that is, a lateral angle change amount WPa of the first folding peripheral area COU1 with respect to an angle at which the first flat display area DA1 is disposed decreases. Likewise, a lateral angle change amount of the second folding peripheral area COU2 may also decrease.

As the folding angle Fa of the display device 10 is narrower, the curvature Cur of the folding area FOU decreases, and the internal curvature between the wing plates WH and WL inside the display device 10 also decreases. As the internal curvature of the folding area FOU and the internal curvature between the wing plates WH and WL decrease, the change in the angle of the first folding peripheral area COU1, that is, the lateral angle change amount WPa of the first folding peripheral area COU1 with respect to the angle at which the first flat display area DA1 is disposed increases. Likewise, the lateral angle change amount of the second folding peripheral area COU2 may also increase.

As the lateral angle change amounts WPa of the first and second folding peripheral areas COU1 and COU2 with respect to the first and second flat display areas DA1 and DA2 increase, the image display luminance and chrominance of the first and second folding peripheral areas COU1 and COU2 become more distorted compared with those of the first and second flat display areas DA1 and DA2. In particular, in a state where a user's gaze is fixed, as the lateral angle change amounts WPa of the first and second folding peripheral areas COU1 and COU2 increase, the image display luminance and chrominance of the first and second folding peripheral areas COU1 and COU2 may become more distorted.

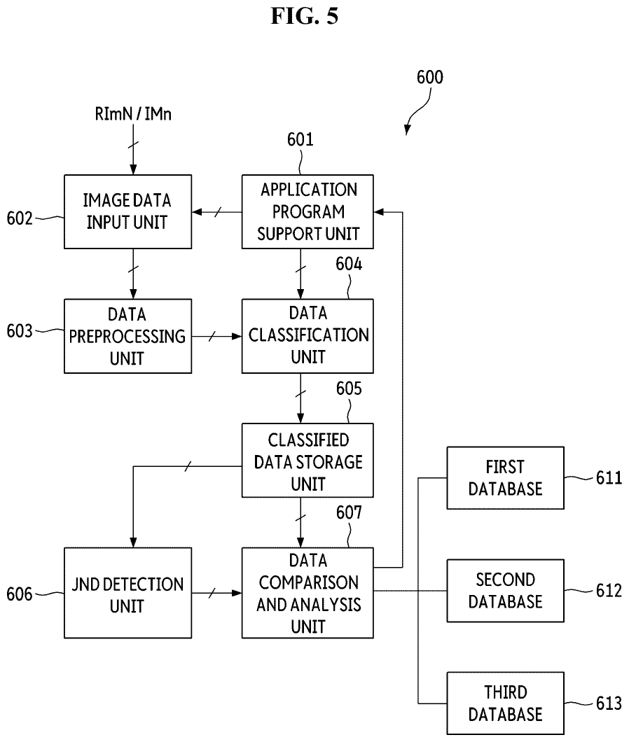

FIG. 5 is a block diagram illustrating detailed components of the quality analyzer 600 illustrated in FIG. 1.

Referring to FIG. 5, the quality analyzer 600 includes an application program support unit 601, an image data input unit 602, a data preprocessing unit 603, a data classification unit 604, a classified data storage unit 605, a just noticeable difference (“JND”) detection unit 606, a data comparison and analysis unit 607, and first through third databases 611, 612 and 613.

The application program support unit 601 displays an application program screen on the display unit 700 such as a monitor and executes a preset learning program according to a user's interface control through an application program. The application program support unit 601 displays the class classification results and quality inspection results of display devices 10 on the application program screen.

The image data input unit 602 sorts first inspection image data RImN for each folding angle and second inspection image data IMn for each folding angle, which are sequentially input from the image capturing device 410 of the image detector 400, in units of at least one frame, matches them with unique product codes of the display devices 10, and stores them with the matched unique product codes. In addition, the image data input unit 602 may store various first and second inspection image data, which have been previously input in a luminance and chrominance distortion degree inspection process, in the first through third databases 611, 612 and 613 in addition to the first and second inspection image data RImN and IMn input from the image capturing device 410.

The data preprocessing unit 603 modulates the resolution and frame size of the first inspection image data RImN for each folding angle and the second inspection image data IMn for each folding angle to a preset resolution and size.

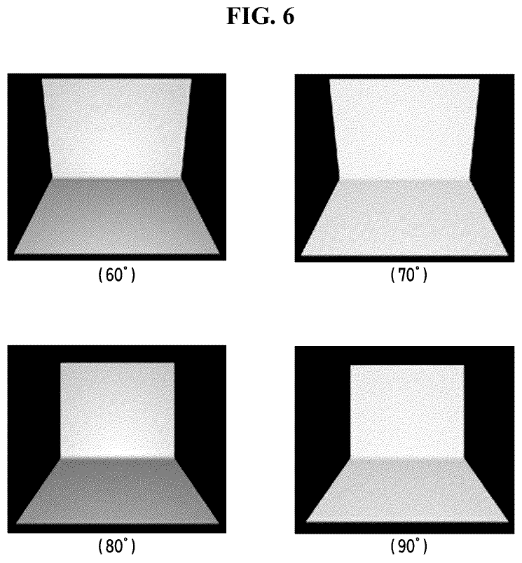

FIG. 6 illustrates, at each folding angle, a display area segmented screen of a display device photographed and detected by the image detector 400 of FIG. 1.

Referring to FIG. 6, the data classification unit 604 extracts and generates segmented screen image data for each folding angle by segmenting the display area DA folded at a predetermined angle from the first inspection image data RImN for each folding angle whose resolution and frame size have been modulated.

As described above, during an inspection period, each display device 10 may be sequentially changed to a folding angle of 60 degrees, 70 degrees, 80 degrees, 90 degrees, etc. for each preset period. Accordingly, the image capturing device 410 may photograph each display device 10 which is sequentially changed to each folding angle and generate the first inspection image data RImN for each folding angle.

The data classification unit 604 extracts and generates segmented screen image data for each folding angle by segmenting the display area DA from the first inspection image data RImN for each folding angle.

The classified data storage unit 605 sequentially stores the first inspection image data RImN for each folding angle, whose resolution and frame size have been modulated by a preprocessing process, in the first database 611. Specifically, the classified data storage unit 605 stores, in the first database 611, first reference class classification image data for determining the degree of luminance and chrominance distortion and quality of the first inspection image data RImN for each folding angle. To this end, the classified data storage unit 605 may store various first inspection image data, which have been previously input in a luminance and chrominance distortion degree inspection process, in the first database 611 in addition to the first inspection image data RImN input in real time.

In addition, the classified data storage unit 605 sequentially stores the segmented screen image data for each folding angle extracted by the data classification unit 604 in the second database 612.

Likewise, the classified data storage unit 605 stores, in the second database 612, reference class screen classification image data for determining the degree of luminance and chrominance distortion and quality of the segmented screen image data for each folding angle. To this end, the classified data storage unit 605 may store various reference class screen classification image data, which have been previously input in a luminance and chrominance distortion degree inspection process, in the second database 612 in addition to the segmented screen image data for each folding angle segmented input in real time.

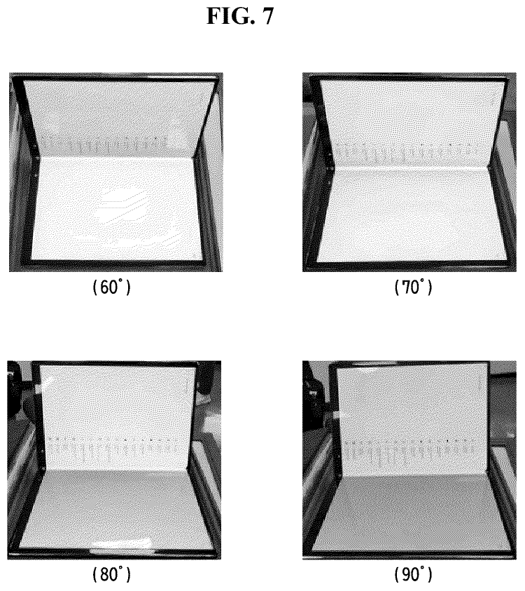

FIG. 7 illustrates, at each folding angle, an image display area of a display device 10 photographed and detected by the image detector 400 of FIG. 1.

As illustrated in FIG. 7, the display device 10 may display a preset inspection image at each preset inspection time during an inspection period in which it is changed to each preset folding angle. Accordingly, the image capturing device 410 sequentially photographs the display device 10 which is changed to each folding angle and displays an inspection image.

The data preprocessing unit 603 modulates and preprocesses the resolution and frame size of the second inspection image data IMn for each folding angle to a preset resolution and size.

The classified data storage unit 605 sequentially stores the second inspection image data IMn for each folding angle, whose resolution and frame size have been modulated by a preprocessing process as in FIG. 7, in the third database 613.

In other words, the classified data storage unit 605 stores second reference class classification image data in the third database 613 in order to determine the degree of luminance and chrominance distortion and quality of the second inspection image data IMn for each folding angle. In particular, the classified data storage unit 605 may store various second inspection image data, which have been previously input in a luminance and chrominance distortion degree inspection process, in the third database 613 in addition to the second inspection image data IMn input in real time.

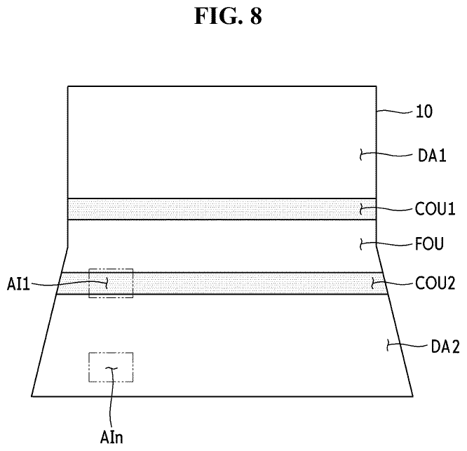

FIG. 8 illustrates a method of extracting sampling areas from a folding peripheral area and a flat area of the display area DA.

Referring to FIG. 8, the JND detection unit 606 detects image-grayscale-chrominance data (e.g., grayscale values and chrominance values or luminance values) of each of any one folding peripheral area COU1 or COU2 and any one flat display area DA1 or DA2 from the first inspection image data RImN for each folding angle.

In an embodiment, the JND detection unit 606 detects image-grayscale-chrominance data (e.g., grayscale values and chrominance values or luminance values) of a preset first sampling area AIl of any one folding peripheral area COU1 or COU2 from the first inspection image data RImN for each folding angle, for example. In addition, it detects image-grayscale-chrominance data (e.g., grayscale values and chrominance values or luminance values) of a preset second sampling area AIn of any one flat display area DA1 or DA2.

The JND detection unit 606 transmits the image-grayscale-chrominance data of each of any one preset first sampling area (also referred to as a first sampling area) AI1 and any one preset second sampling area (also referred to as a second sampling area) AIn to the data comparison and analysis unit 607.

In addition, the JND detection unit 606 detects image-grayscale-chrominance data (e.g., grayscale values and chrominance values or luminance values) of each of any one folding peripheral area COU1 or COU2 and any one flat display area DA1 or DA2 from the segmented screen image data for each folding angle. That is, the JND detection unit 606 detects image-grayscale-chrominance data of each of the first sampling area AI1 and the second sampling area AIn from the segmented screen image data for each folding angle and transmits the detected image-grayscale-chrominance data to the data comparison and analysis unit 607.

In addition, the JND detection unit 606 detects image-grayscale-chrominance data (e.g., grayscale values and chrominance values or luminance values) of each of any one folding peripheral area COU1 or COU2 and any one flat display area DA1 or DA2 from the second inspection image data IMn for each folding angle. That is, the JND detection unit 606 detects image-grayscale-chrominance data of each of the first sampling area AI1 and the second sampling area AIn from the second inspection image data IMn for each folding angle and transmits the detected image-grayscale-chrominance data to the data comparison and analysis unit 607.

The data comparison and analysis unit 607 compares the image-grayscale-chrominance data of the folding peripheral area COU1 or COU2 with the image-grayscale-chrominance data of the flat display area DA1 or DA2 for each piece of the first inspection image data RImN for each folding angle and extracts difference data values between the grayscale and chrominance data. Hereinafter, the difference data values extracted from the data comparison and analysis unit 607 may be also referred to “extracted grayscale-chrominance-difference data values”. Then, it determines the classes of corresponding display devices 10 and whether the corresponding display devices 10 are non-defective based on the extracted grayscale-chrominance-difference data values.

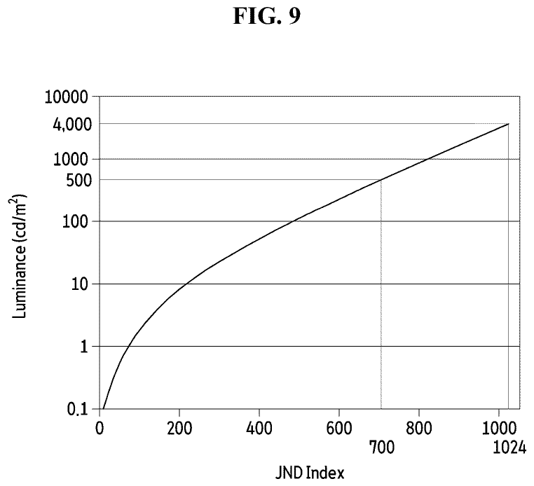

FIG. 9 is a graph illustrating a method of analyzing a difference in luminance between sampling areas in a folding peripheral area and a flat area of FIG. 8.

The luminance of the flat display area DA1 or DA2 may be analyzed and extracted based on an image grayscale value of the flat display area DA1 or DA2 included in the first inspection image data RImN. In addition, the luminance of the folding peripheral area COU1 or COU2 may be analyzed and extracted based on an image grayscale value of the folding peripheral area COU1 or COU2 included in the first inspection image data RImN.

In an embodiment, when the luminance of the flat display area DA1 or DA2 is analyzed as 750 candela per square meter (cd/m²) and the luminance of the folding peripheral area COU1 or COU2 is analyzed as 250 cd/m², a difference in luminance between the flat display area DA1 or DA2 and the folding peripheral area COU1 or COU2 may be analyzed as 500 cd/m², for example. According to preset experimental values, when the difference in luminance between the flat display area DA1 or DA2 and the folding peripheral area COU1 or COU2 is 500 cd/m², a JND calculation index may be analyzed as about 700 points. As the JND calculation index increases, the degree of distortion perceived by a user's eyes increases. Therefore, the greater the difference value between the image grayscale value of the flat display area DA1 or DA2 and the image grayscale value of the folding peripheral area COU1 or COU2, the greater the JND calculation index. Therefore, the greater the difference value between the image grayscale value of the flat display area DA1 or DA2 and the image grayscale value of the folding peripheral area COU1 or COU2, the greater the distortion between the flat display area DA1 or DA2 and the folding peripheral area COU1 or COU2 and the higher the defect rate.

Thus, the data comparison and analysis unit 607 sets a JND calculation index for each piece of the first inspection image data RImN for each folding angle according to a grayscale and chrominance difference data value of each piece of the first inspection image data RImN for each folding angle.

In the same way, the data comparison and analysis unit 607 may set and store a JND calculation index for each piece of the first reference class classification image data according to a grayscale and chrominance difference data value of each piece of the first reference class classification image data stored in advance in the first database 611.

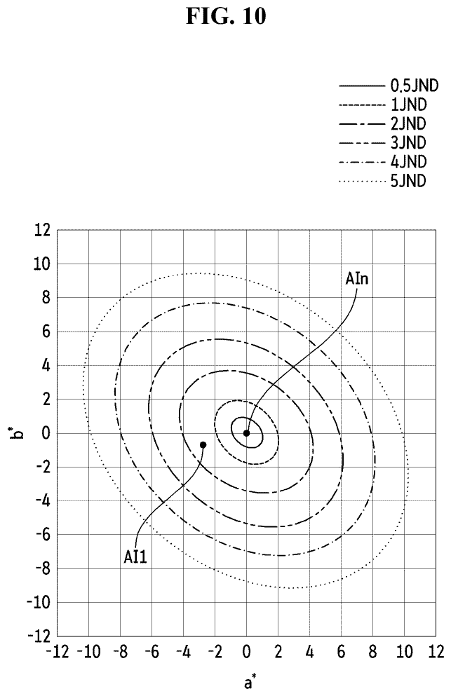

FIG. 10 is a graph illustrating a method of analyzing the chrominance of sampling areas in a peripheral area and a flat area of FIG. 8.

Referring to FIG. 10, a chrominance data value of the first sampling area AI1 and a chrominance data value of the second sampling area AIn may be compared with each other using first and second chrominance coordinate systems a* and b* according to an example. In this case, the greater the difference value between the chrominance data value of the folding peripheral area COU1 or COU2 and the chrominance data value of the flat display area DA1 or DA2, the greater the JND calculation index. In addition, the greater the difference value between the chrominance data values, the greater the perceived distortion between the flat display area DA1 or DA2 and the folding peripheral area COU1 or COU2.

Referring to FIGS. 9 and 10, the data comparison and analysis unit 607 compares the image-grayscale-chrominance data of the folding peripheral area COU1 or COU2 with the image-grayscale-chrominance data of the flat display area DA1 or DA2 for each piece of the segmented screen image data for each folding angle and extracts difference data values between the grayscale and chrominance data. Then, it may calculate and set a JND calculation index according to each of the extracted grayscale-chrominance-difference data values and determine the classes of corresponding display devices 10 and whether the corresponding display devices 10 are non-defective by comparing the JND calculation indices.

In an alternative embodiment, the data comparison and analysis unit 607 may extract a difference data value between the image-grayscale-chrominance data of the folding peripheral area COU1 or COU2 and the image-grayscale-chrominance data of the flat display area DA1 or DA2 for each piece of the second inspection image data IMn for each folding angle. Then, it may set a JND calculation index according to each extracted difference data value between the grayscale and chrominance data and determine the classes of corresponding display devices 10 and whether the corresponding display devices 10 are non-defective using the JND calculation indices.

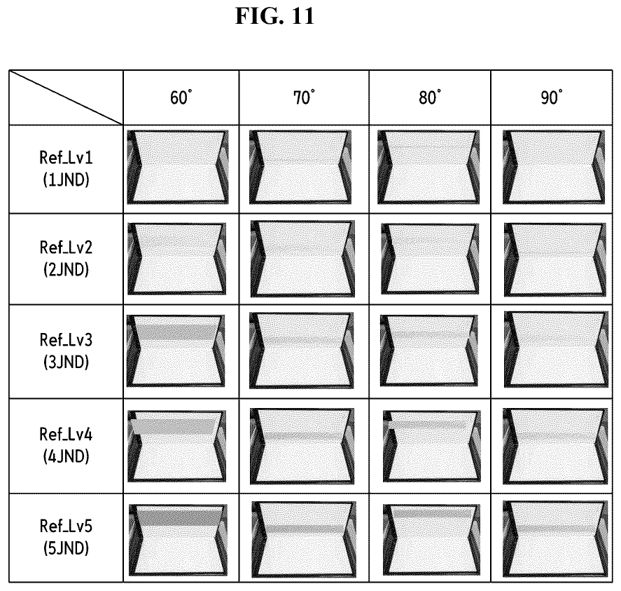

FIG. 11 is an example classification diagram illustrating first reference image data stored in the first database 611 of FIG. 5 by folding angle and determination standard.

As described above, the first database 611 stores previous first inspection image data having preset JND calculation indices and first inspection image data generated according to an experimental process. The first inspection image data stored in the first database 611 may be classified into different levels or grades according to the preset JND calculation indices.

Referring to FIG. 11, the data comparison and analysis unit 607 extracts a JND calculation index for each piece of the first inspection image data RImN for each folding angle according to a grayscale and chrominance difference data value of each piece of the first inspection image data RImN input from the JND detection unit 606 in real time. Then, it sequentially compares the JND calculation index of each piece of the first inspection image data RImN with JND calculation indices of the first reference class classification image data stored in advance in the first database 611.

The data comparison and analysis unit 607 may classify and set the class of each piece of the first inspection image data RImN to the class (e.g., the class of any one of first through fifth levels Ref_Lv1 through Ref_Lv5) of any one piece of the first reference class classification image data, whose JND calculation index is most similar to image-grayscale-chrominance-difference data of the piece of the first inspection image data RImN, based on the comparison result.

Then, the data comparison and analysis unit 607 may determine and derive whether a corresponding display device 10 is non-defective according to a preset quality determination standard level. In an embodiment, display devices 10 classified and distinguished as the class of the first level Ref_Lv1 may be determined to be non-defective, and display devices 10 classified and distinguished as the classes of the second through fifth levels Ref_Lv2 through Ref_Lv5 may be determined to be defective, for example.

The data comparison and analysis unit 607 shares the class classification results and the quality inspection results of the display devices 10 with the application program support unit 601, and the application program support unit 601 displays the class classification result and the quality inspection result of each display device 10 on an application program screen.

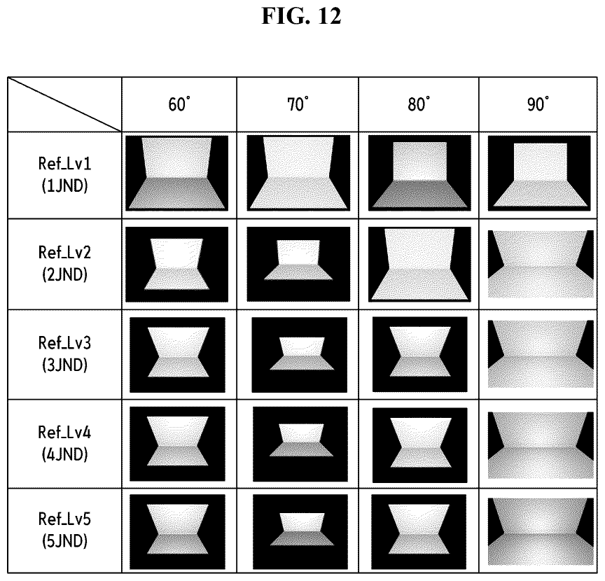

FIG. 12 is an example classification diagram illustrating second reference image data stored in the second database 612 of FIG. 5 by folding angle and determination standard.

Referring to FIG. 12, the data comparison and analysis unit 607 extracts a JND calculation index for each piece of the segmented screen image data for each folding angle according to a grayscale and chrominance difference data value of each piece of the segmented screen image data for each folding angle input from the JND detection unit 606 in real time. Then, it sequentially compares the JND calculation index of each piece of the segmented screen image data for each folding angle with JND calculation indices of the reference class screen classification image data stored in advance in the second database 612.

The data comparison and analysis unit 607 may classify and set the class of each piece of the segmented screen image data to the class (e.g., the class of any one of the first through fifth levels Ref_Lv1 through Ref_Lv5) of any one piece of the reference class screen classification image data, whose JND calculation index is most similar to image-grayscale-chrominance-difference data of the piece of the segmented screen image data, based on the comparison result.

Then, the data comparison and analysis unit 607 may determine and derive whether a corresponding display device 10 is non-defective according to a preset quality determination standard level. In an embodiment, display devices 10 classified and distinguished as the class of the first level Ref_Lv1 may be determined to be non-defective, and display devices 10 classified and distinguished as the classes of the second through fifth levels Ref_Lv2 through Ref_Lv5 may be determined to be defective, for example.

The data comparison and analysis unit 607 shares the class classification results and the quality inspection results of the display devices 10 with the application program support unit 601, and the application program support unit 601 displays the class classification result and the quality inspection result of each display device 10 on an application program screen.

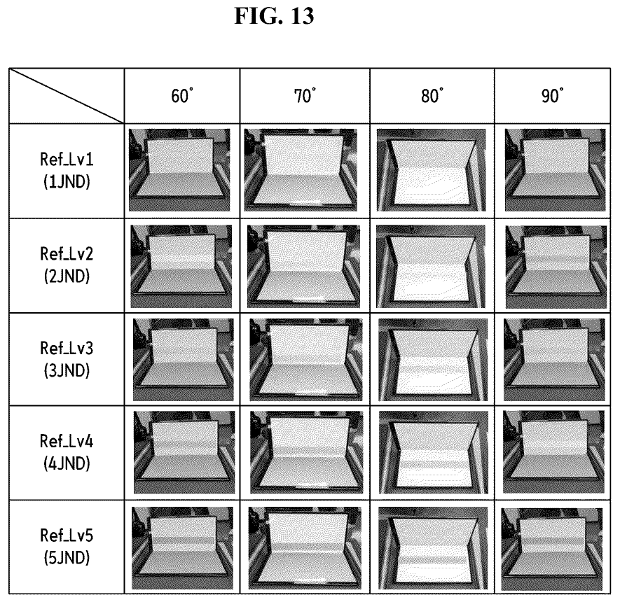

FIG. 13 is an example classification diagram illustrating third reference image data stored in the third database 613 of FIG. 5 by folding angle and determination standard.

Referring to FIG. 13, the data comparison and analysis unit 607 extracts a JND calculation index for each piece of the second inspection image data IMn for each folding angle according to a grayscale and chrominance difference data value of each piece of the second inspection image data IMn input from the JND detection unit 606 in real time. Then, it sequentially compares the JND calculation index of each piece of the second inspection image data IMn with JND calculation indices of the second reference class classification image data stored in advance in the third database 613.

The data comparison and analysis unit 607 may classify and set the class of each piece of the second inspection image data IMn to the class (e.g., the class of any one of the first through fifth levels Ref_Lv1 through Ref_Lv5) of any one piece of the second reference class classification image data, whose JND calculation index is most similar to image-grayscale-chrominance-difference data of the piece of the second inspection image data IMn, based on the comparison result.

Then, the data comparison and analysis unit 607 may determine and derive whether a corresponding display device 10 is non-defective according to a preset quality determination standard level. In an embodiment, display devices 10 classified and distinguished as the class of the first level Ref_Lv1 may be determined to be non-defective, and display devices 10 classified and distinguished as the classes of the second through fifth levels Ref_Lv2 through Ref_Lv5 may be determined to be defective, for example.

The data comparison and analysis unit 607 shares the class classification results and the quality inspection results of the display devices 10 with the application support program unit 601, and the application program support unit 601 displays the class classification result and the quality inspection result of each display device 10 on an application program screen.

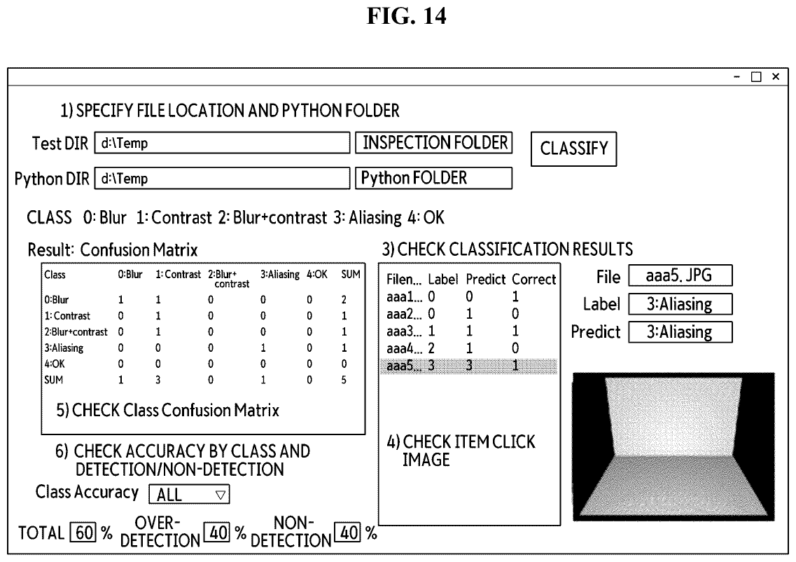

FIG. 14 illustrates an application program screen displayed through a monitor.

Referring to FIG. 14, the application program support unit 601 provides an interface screen on the display unit 700 so that an administrator may select a first folder where the first inspection image data RImN are stored and a second folder where the second inspection image data IMn are stored and execute a classification and evaluation learning process of the first inspection image data RImN.

The first inspection image data RImN for each folding angle may be stored in the first folder (e.g., “Test DIR” inspection folder) designated by the administrator. Additionally, the first reference class classification image data, the reference class screen classification image data, and the second reference class classification image data may be stored in other folders.

The administrator may perform a learning and analysis operation on the first inspection image data RImN or the second inspection image data IMn through a classification execution command and check the class level of each corresponding display device 10 and whether each corresponding display device 10 is non-defective. In other words, the classification results may be checked through an application program.

In concluding the detailed description, those skilled in the art will appreciate that many variations and modifications may be made to the preferred embodiments without substantially departing from the principles of the disclosure. Therefore, the disclosed preferred embodiments of the disclosure are used in a generic and descriptive sense only and not for purposes of limitation.

What is claimed is:

1. An inspection system for image display devices, the inspection system comprising:
an image detector which generates inspection image data in units of at least one frame by photographing image display devices folded at preset folding angles; and
a quality analyzer which classifies a class of each of the folded image display devices and determines whether each of the image display devices which are folded is non-defective by comparing the inspection image data with reference class classification image data, which are classified by the class, through a preset learning program.

2. The inspection system of claim 1, wherein the image detector comprises:
at least one loading plate which places the image display devices defining a folding angle which is maintained or changed, at a preset photographing position;
an image capturing device which generates and detects the inspection image data in units of at least one frame by sequentially photographing the image display devices defining the folding angle which is maintained or changed;
a body frame which changes or fixes a photographing position of the image capturing device; and
a chamber defining a darkroom space in which the image display devices are photographed.

3. The inspection system of claim 2, wherein the image detector generates first inspection image data for each of folding angles of the image display devices by photographing the image display devices, which are sequentially changed to each of the preset folding angles, using the image capturing device, generates second inspection image data for each of the folding angles by sequentially photographing the image display devices which are changed to each of the preset folding angles while displaying a preset inspection image, and sequentially transmits the first inspection image data for each of the folding angles and the second inspection image data for each of the folding angles to the quality analyzer.

4. The inspection system of claim 3, wherein the quality analyzer extracts segmented screen image data for each of the folding angles by segmenting an image display area of each of the image display devices from the first inspection image data for each of the folding angles, prepares first reference class classification image data for determining a degree of luminance and chrominance distortion and quality of the first inspection image data for each of the folding angles and stores the first reference class classification image data in a first database, prepares reference class screen classification image data for determining a degree of luminance and chrominance distortion and quality of the segmented screen image data for each of the folding angles and stores the reference class screen classification image data in a second database, and prepares second reference class classification image data for determining a degree of luminance and chrominance distortion and quality of the second inspection image data for each of the folding angles and stores the second reference class classification image data in a third database.

5. The inspection system of claim 4, wherein the quality analyzer detects image-grayscale-chrominance-difference data between a folding peripheral area and a flat display area of the first inspection image data, compares the image-grayscale-chrominance-difference data with image-grayscale-chrominance-difference data between the folding peripheral area and the flat display area of the first reference class classification image data, classifies and sets the class of each of pieces of the first inspection image data to the class of any one piece of the first reference class classification image data including image-grayscale-chrominance-difference data which is most similar to image-grayscale-chrominance-difference data of a piece of the first inspection image data among the pieces of the first inspection image data, based on a comparison result, displays a result of classifying and setting the class of each of the first inspection image data on a result screen of an application program, and determines whether a corresponding image display device is non-defective based on the classified and set class of each of the pieces of the first inspection image data.

6. The inspection system of claim 5, wherein the quality analyzer detects image-grayscale-chrominance-difference data between a folding peripheral area and a flat display area of the segmented screen image data for each of the folding angles, compares the image-grayscale-chrominance-difference data with image-grayscale-chrominance-difference data between the folding peripheral area and the flat display area of the reference class screen classification image data, classifies and sets the class of each of the pieces of the segmented screen image data for each of the folding angles to the class of any one piece of the reference class screen classification image data including image-grayscale-chrominance-difference data which is most similar to image-grayscale-chrominance-difference data of a piece of the segmented screen image data among the pieces of the segmented screen image data, based on the comparison result and then determines whether a corresponding image display device is non-defective based on the classified and set class of each of the pieces of the segmented screen image data or detects image-grayscale-chrominance-difference data between a folding peripheral area and a flat display area of the second inspection image data, compares the image-grayscale-chrominance-difference data with image-grayscale-chrominance-difference data between the folding peripheral area and the flat display area of the second reference class classification image data, classifies and sets the class of each of pieces of the second inspection image data to the class of any one piece of the second reference class classification image data including image-grayscale-chrominance-difference data which is most similar to image-grayscale-chrominance-difference data of a piece of the second inspection image data among the pieces of the second inspection image data, based on the comparison result and then determines whether a corresponding image display device is non-defective based on the classified and set class of each of the pieces of the second inspection image data.

7. The inspection system of claim 3, wherein the quality analyzer comprises:
an application program support unit which displays an application program screen on a display unit and displays class classification and quality inspection results of the image display devices according to an interface control of a user through an application program;
an image data input unit which matches the first inspection image data for each of the folding angles and the second inspection image data for each of the folding angles with unique product codes of the image display devices and stores the first and second inspection image data with the matched unique product codes;
a data preprocessing unit which modulates a resolution and a frame size of the first inspection image data for each of the folding angles and the second inspection image data for each of the folding angles to a preset resolution and size;
a data classification unit which extracts the segmented screen image data for each of the folding angles by segmenting the image display area of each of the image display devices from the first inspection image data for each of the folding angles;
a just noticeable difference detection unit which detects image-grayscale-chrominance data of a folding peripheral area and a flat display area from each of the first inspection image data for each of the folding angles, the segmented screen image data for each of the folding angles, and the second inspection image data for each of the folding angles; and
a data comparison and analysis unit which extracts a difference data value between the image-grayscale-chrominance data of the folding peripheral area and the image-grayscale-chrominance data of the flat display area from each of the first inspection image data for each of the folding angles, the segmented screen image data for each of the folding angles and the second inspection image data for each of the folding angles and determines the class of a corresponding image display device and whether the corresponding image display device is non-defective based on each extracted difference data value.

8. The inspection system of claim 7, wherein the data comparison and analysis unit extracts the difference data value between image-grayscale-chrominance data of a folding peripheral area and image-grayscale-chrominance data of a flat display area from each of pieces of the first reference class classification image data and stores a just noticeable difference calculation index corresponding to the difference data value, sets a just noticeable difference calculation index for each of pieces of the first inspection image data for each of the folding angles according to the grayscale and chrominance difference data value of each of the pieces of the first inspection image data for each of the folding angles, sequentially compares the just noticeable difference calculation indices for the first reference class classification image data with the just noticeable difference calculation indices for the first inspection image data, classifies and sets the class of each of the pieces of the first inspection image data based on the comparison result, and determines whether a corresponding image display device is non-defective according to the class of each of the pieces of the first inspection image data.

9. The inspection system of claim 7, wherein the data comparison and analysis unit extracts the difference data value between image-grayscale-chrominance data of a folding peripheral area and image-grayscale-chrominance data of a flat display area from each of pieces of the reference class screen classification image data and stores a just noticeable difference calculation index corresponding to the difference data value, sets a just noticeable difference calculation index for each of pieces of the segmented screen image data for each of the folding angles according to the grayscale and chrominance difference data value of each of the pieces of the segmented screen image data for each of the folding angles, sequentially compares the just noticeable difference calculation indices for the reference class screen classification image data with the just noticeable difference calculation indices for the segmented screen image data for each of the folding angles, classifies and sets the class of each of the pieces of the segmented screen image data for each of the folding angles based on the comparison result, and determines whether a corresponding image display device is non-defective according to the class of each of the pieces of the segmented screen image data.

10. The inspection system of claim 7, wherein the data comparison and analysis unit extracts the difference data value between the image grayscale and the chrominance data of the folding peripheral area and the image-grayscale-chrominance data of the flat display area from each of pieces of the second reference class classification image data and stores the just noticeable difference calculation index corresponding to the difference data value, sets the just noticeable difference calculation index for each of pieces of the second inspection image data for each of the folding angles according to the grayscale and chrominance difference data value of each of the pieces of the second inspection image data for each of the folding angles, sequentially compares the just noticeable difference calculation indices for the second reference class classification image data with the just noticeable difference calculation indices for the second inspection image data, classifies and sets the class of each of the pieces of the second inspection image data based on the comparison result, and determines whether a corresponding image display device is non-defective according to the class of each of the pieces of the second inspection image data.

11. An inspection system for image display devices, the inspection system comprising:
an image detector which generates inspection image data in units of at least one frame by photographing image display devices folded at preset folding angles; and
a quality analyzer which classifies a class of each of the folded image display devices and determines whether each of the folded image display devices is non-defective by comparing the inspection image data with reference class classification image data, which are classified by the class, through a preset learning program,
wherein the image detector generates first inspection image data for each of the folding angles by photographing the image display devices, which are sequentially changed to each of the preset folding angles, using the image capturing device, generates second inspection image data for each of the folding angles by sequentially photographing the image display devices which are changed to each of the preset folding angles while displaying a preset inspection image, and transmits the first inspection image data for each of the folding angles and the second inspection image data for each of the folding angles to the quality analyzer.

12. The inspection system of claim 11, wherein the quality analyzer extracts segmented screen image data for each of the folding angles by segmenting an image display area of each of the image display devices from the first inspection image data for each of the folding angles, prepares first reference class classification image data for determining a degree of luminance and chrominance distortion and quality of the first inspection image data for each of the folding angles and stores the first reference class classification image data in a first database, prepares reference class screen classification image data for determining a degree of luminance and chrominance distortion and quality of the segmented screen image data for each of the folding angles and stores the reference class screen classification image data in a second database, and prepares second reference class classification image data for determining a degree of luminance and chrominance distortion and quality of the second inspection image data for each of the folding angles and stores the second reference class classification image data in a third database.

13. The inspection system of claim 12, wherein the quality analyzer detects image-grayscale-chrominance-difference data between a folding peripheral area and a flat display area of the first inspection image data, compares the image-grayscale-chrominance-difference data with image-grayscale-chrominance-difference data between the folding peripheral area and the flat display area of the first reference class classification image data, classifies and sets the class of each of pieces of the first inspection image data to the class of any one piece of the first reference class classification image data including image-grayscale-chrominance-difference data which is most similar to image-grayscale-chrominance-difference data of a piece of the first inspection image data among the pieces of the first inspection image data, based on a comparison result, displays a result of classifying and setting the class of each of the first inspection image data on a result screen of an application program, and determines whether a corresponding image display device is non-defective based on the classified and set class of each of the pieces of the first inspection image data.

14. The inspection system of claim 13, wherein the quality analyzer detects image-grayscale-chrominance-difference data between a folding peripheral area and a flat display area of the segmented screen image data for each of the folding angles, compares the image-grayscale-chrominance-difference data with image-grayscale-chrominance-difference data between the folding peripheral area and the flat display area of the reference class screen classification image data, classifies and sets the class of each of pieces of the segmented screen image data for each of the folding angles to the class of any one piece of the reference class screen classification image data including image-grayscale-chrominance-difference data which is most similar to image-grayscale-chrominance-difference data of a piece of the segmented screen image data among the pieces of the segmented screen image data, based on the comparison result and then determines whether a corresponding image display device is non-defective based on the classified and set class of each of the pieces of the segmented screen image data or detects image-grayscale-chrominance-difference data between a folding peripheral area and a flat display area of the second inspection image data, compares the image-grayscale-chrominance-difference data with image-grayscale-chrominance-difference data between the folding peripheral area and the flat display area of the second reference class classification image data, classifies and sets the class of each of pieces of the second inspection image data to the class of any one piece of the second reference class classification image data including image-grayscale-chrominance-difference data which is most similar to image-grayscale-chrominance-difference data of a piece of the second inspection image data among the image-grayscale-chrominance-difference data, based on the comparison result and then determines whether a corresponding image display device is non-defective based on the classified and set class of each of the pieces of the second inspection image data.

15. The inspection system of claim 12, wherein the quality analyzer comprises:
an application program support unit which displays an application program screen on a display unit and displays class classification and quality inspection results of the image display devices according to an interface control of a user through an application program;
an image data input unit which matches the first inspection image data for each of the folding angles and the second inspection image data for each of the folding angles with unique product codes of the image display devices and stores the first and second inspection image data with the matched unique product codes;
a data preprocessing unit which modulates a resolution and a frame size of the first inspection image data for each of the folding angles and the second inspection image data for each of the folding angles to a preset resolution and size;
a data classification unit which extracts the segmented screen image data for each of the folding angles by segmenting the image display area of each of the image display devices from the first inspection image data for each of the folding angles;
a just noticeable difference detection unit which detects image-grayscale-chrominance data of a folding peripheral area and a flat display area from each of the first inspection image data for each of the folding angles, the segmented screen image data for each of the folding angles, and the second inspection image data for each of the folding angles; and
a data comparison and analysis unit which extracts a difference data value between the image-grayscale-chrominance data of the folding peripheral area and the image-grayscale-chrominance data of the flat display area from each of the first inspection image data for each of the folding angles, the segmented screen image data for each of the folding angles and the second inspection image data for each of the folding angles and determines the class of a corresponding image display device and whether the corresponding image display device is non-defective based on each extracted difference data value.

16. The inspection system of claim 15, wherein the data comparison and analysis unit extracts a difference data value between image-grayscale-chrominance data of a folding peripheral area and image-grayscale-chrominance data of a flat display area from each piece of the first reference class classification image data and stores a just noticeable difference calculation index corresponding to the difference data value, sets a just noticeable difference calculation index for each piece of the first inspection image data for each of the folding angles according to the grayscale and chrominance difference data value of each piece of the first inspection image data for each of the folding angles, sequentially compares the just noticeable difference calculation indices for the first reference class classification image data with the just noticeable difference calculation indices for the first inspection image data, classifies and sets the class of each piece of the first inspection image data based on the comparison result, and determines whether a corresponding image display device is non-defective according to the class of each piece of the first inspection image data.

17. The inspection system of claim 15, wherein the data comparison and analysis unit extracts a difference data value between image-grayscale-chrominance data of a folding peripheral area and image-grayscale-chrominance data of a flat display area from each piece of the reference class screen classification image data and stores a just noticeable difference calculation index corresponding to the difference data value, sets a just noticeable difference calculation index for each piece of the segmented screen image data for each of the folding angles according to the grayscale and chrominance difference data value of each piece of the segmented screen image data for each of the folding angles, sequentially compares the just noticeable difference calculation indices for the reference class screen classification image data with the just noticeable difference calculation indices for the segmented screen image data for each of the folding angles, classifies and sets the class of each piece of the segmented screen image data for each of the folding angles based on the comparison result, and determines whether a corresponding image display device is non-defective according to the class of each piece of the segmented screen image data.

18. The inspection system of claim 15, wherein the data comparison and analysis unit extracts a difference data value between image-grayscale-chrominance data of a folding peripheral area and image-grayscale-chrominance data of a flat display area from each of pieces of the second reference class classification image data and stores a just noticeable difference calculation index corresponding to the difference data value, sets a just noticeable difference calculation index for each of pieces of the second inspection image data for each of the folding angles according to the grayscale and chrominance difference data value of each of the pieces of the second inspection image data for each of the folding angles, sequentially compares the just noticeable difference calculation indices for the second reference class classification image data with the just noticeable difference calculation indices for the second inspection image data, classifies and sets the class of each of the pieces of the second inspection image data based on the comparison result, and determines whether a corresponding image display device is non-defective according to the class of each of the pieces of the second inspection image data.
